(19) United States
(12) Patent Application Publication
(10) Pub. No.: US 2020/0172165 A1
(43) Pub. Date: Jun. 4, 2020

(54) VEHICLE WHEEL DIAGNOSTIC

(71) Applicant: Ford Global Technologies, LLC, Dearborn, MI (US)

(72) Inventors: QI CHEN, Canton, MI (US); HONGTEI ERIC TSENG, Canton, MI (US); LU XU, Canton, MI (US); LINJUN ZHANG, Canton, MI (US); YUCONG LIN, Canton, MI (US)

(73) Assignee: Ford Global Technologies, LLC, Dearborn, MI (US)

(21) Appl. No.: 16/208,803

(22) Filed: Dec. 4, 2018

(51) Int. Cl. B62D 7/15; B62D 6/00; B62D 15/02; B60W 10/20

(52) U.S. Cl. CPC B62D 7/159; B62D 6/008; B62D 5/046; B60W 10/20; B62D 15/025

(57) ABSTRACT

A system includes a computer including a processor and a memory, the memory storing instructions executable by the processor to determine that a steering disturbance based on a difference between current vehicle state data and corresponding vehicle state model data exceeds a threshold, the vehicle state model including a yaw rate and a vehicle speed and, then, identify a wheel misalignment condition.

### BACKGROUND

Wheels in a vehicle are typically aligned to allow the vehicle to move substantially straight ahead when a steering wheel is at a specified position, sometimes referred to as a neutral position. During operation of the vehicle, one or more road wheels may become misaligned, causing the vehicle to move away from straight ahead motion when the steering wheel is at a specified neutral position. To compensate, a user may rotate the steering wheel away from the neutral position. Misaligned wheels can damage to wheels and other vehicle parts, and increase maintenance needed for the vehicle.

### BRIEF DESCRIPTION OF THE DRAWINGS

FIG. 1 is a block diagram of an example system for identifying a wheel misalignment condition in a vehicle.

FIG. 2 is an example diagram of motion of the vehicle.

FIG. 3 is an example diagram of motion of the vehicle in a Cartesian coordinate system.

FIG. 4 is an example diagram of motion of the vehicle in a localized coordinate system.

FIG. 5 is a block diagram of an example process for identifying the wheel misalignment condition.

### DETAILED DESCRIPTION

A system includes a computer including a processor and a memory, the memory storing instructions executable by the processor to determine that a steering disturbance based on a difference between current vehicle state data and corresponding vehicle state model data exceeds a threshold, the vehicle state model including a yaw rate and a vehicle speed and, then, identify a wheel misalignment condition.

The instructions can further include instructions to adjust a steering component based on the steering disturbance.

The vehicle state data can further include at least one of a lateral offset or a lateral velocity.

The instructions can further include instructions to update the vehicle state model based on the current vehicle state data.

The instructions can further include instructions to update the vehicle state model based on the difference.

The vehicle state model can include state data of at least one of a lateral velocity, a heading angle, or a lateral offset.

The instructions can further include instructions to identify the difference based on a model state update feedback and a disturbance estimation feedback.

The instructions can further include instructions to determine the model state update feedback and the disturbance estimation feedback based on a minimized cost function.

The instructions can further include instructions to update the state model based on the steering disturbance.

The instructions can instructions further include instructions to identify the steering disturbance based on a minimized cost function.

A method includes determining that a steering disturbance based on a difference between collected vehicle state data and corresponding state data from a vehicle state model exceeds a threshold, the vehicle state model including a yaw rate and a vehicle speed and, then, identifying a wheel misalignment condition.

The method can further include adjusting a steering component based on the steering disturbance.

The collected vehicle state data can further include at least one of a lateral offset or a lateral velocity.

The vehicle state model can further include state data of at least one of a lateral velocity, a heading angle, or a lateral offset.

The method can further include identifying the steering disturbance based on a model state update feedback and a disturbance estimation feedback.

A system includes a wheel, means for determining that a steering disturbance based on a difference between collected vehicle state data and corresponding state data from a vehicle state model exceeds a threshold, the vehicle state model including data of a yaw rate and a vehicle speed, and means for identifying a wheel misalignment condition of the wheel.

The system can further include means for adjusting a steering component based on the steering disturbance.

The collected vehicle state data can further include at least one of a lateral offset, a lateral velocity, or a lateral offset.

The vehicle state model can further include state data of at least one of a lateral velocity, a heading angle, or a lateral offset.

The system can further include means for identifying the steering disturbance based on a model state update feedback and a disturbance estimation feedback.

Determining a steering disturbance for a vehicle directly poses difficulties. A user could feel the disturbance as a vibration or rotation of a steering wheel. However, in a vehicle lacking a steering wheel or in which a user is not touching the steering wheel, e.g., an autonomous vehicle in which steering operations are carried out by commands from a computer, it is a problem for the computer to identify such a vibration or rotation. This problem can be addressed by utilizing vehicle state model data in the computer to determine a steering disturbance model. The computer can compare the vehicle state model data to measured vehicle state data and update the vehicle state model. Upon determining that a difference between the vehicle state model data and the measured vehicle state data is below a threshold, the computer can then use the vehicle state model to model a steering disturbance, which is substantially an actual steering disturbance because the vehicle state model is substantially equal to the measured vehicle state data. When the modeled steering disturbance is above a threshold, the computer can identify a wheel misalignment condition, indicating that one or more wheels of the vehicle is misaligned.

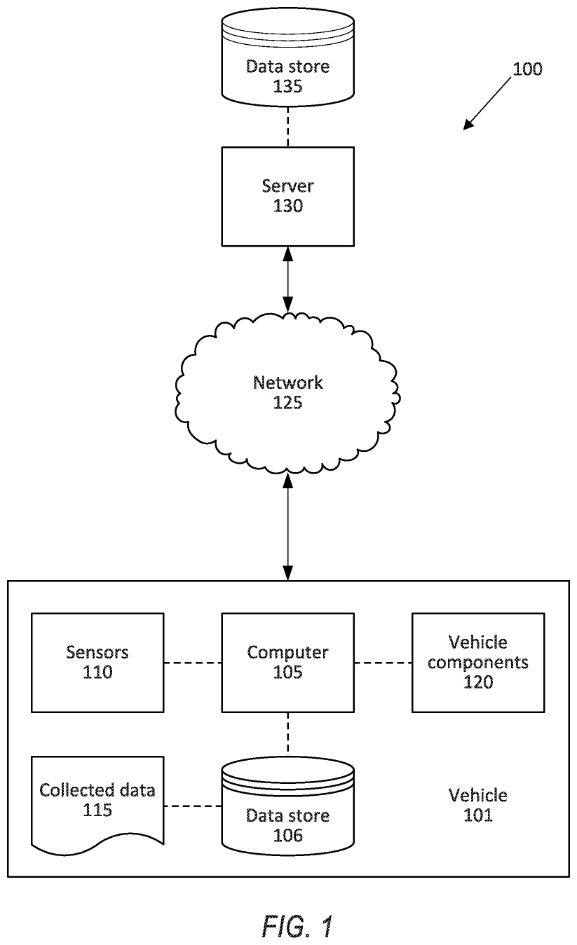

FIG. 1 illustrates an example vehicle wheel diagnostic system 100. The system 100 includes a computer 105 that can be programmed to identify a wheel alignment condition of a wheel in a vehicle 101. The computer 105, typically included in a vehicle 101, is programmed to receive collected data 115 from one or more sensors 110. For example, vehicle 101 data 115 may include a location of the vehicle 101, data about an environment around a vehicle 101, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 can be of any type, e.g., hard disk drives, solid state drives, servers, or any volatile or non-volatile media. The data store 106 can store the collected data 115 sent from the sensors 110.

Sensors 110 can include a variety of devices. For example, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

Collected data 115 can include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, or the like.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator. In a non-autonomous mode, i.e., a manual mode, the vehicle 101 propulsion, braking, and steering are controlled by the human operator.

The system 100 can further include a network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

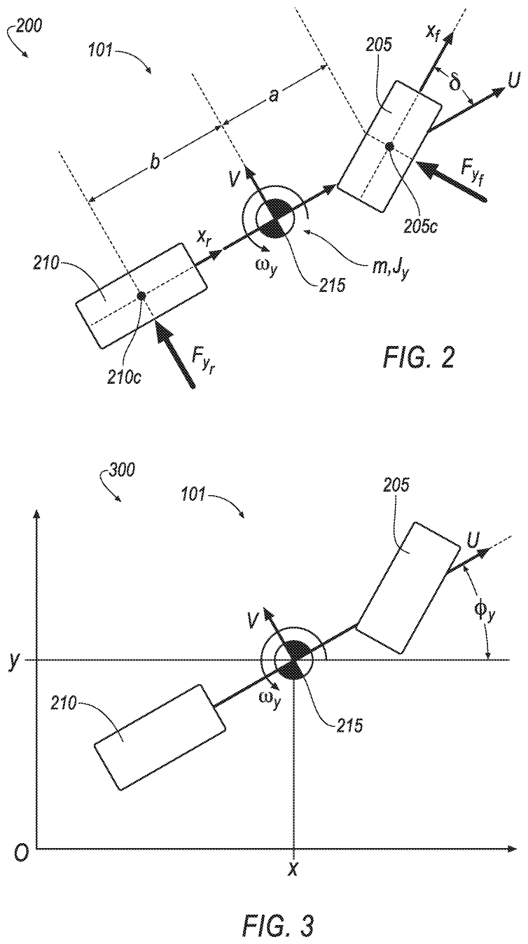

FIG. 2 is a diagram 200 illustrating dynamics of an example vehicle 101. The “dynamics” of the vehicle 101 refers to a set of physical measurements of the vehicle 101 at a point in time, typically including are forces, moments, and velocities of the vehicle 101 resulting from movement of the vehicle 101. The vehicle 101 includes a set of front wheels 205 and a set of rear wheels 210. In the diagram 200, for simplicity of illustration, two front wheels 205 are represented as a single wheel 205, and two rear wheels 210 are represented as a single wheel 210, i.e., as a bicycle would typically have. The wheels 205, 210 moveably support the vehicle 101 body, and allow for turning the vehicle 101. The front wheel 205 defines a steering angle δ relative to a forward trajectory of the vehicle 101. The “forward trajectory” is a line in the direction of a forward velocity U, i.e., the direction that the vehicle 101 moves without input from a steering component 120. The steering component 120 can move the front wheel 205 to the steering angle δ to steer the vehicle 101. Each wheel 205, 210 receives a lateral force F_{y}, i.e., the front wheel 205 receives a front lateral force F_{yf}, and the rear wheel 210 receives a rear lateral force F_{yr}. The lateral forces F_{yf}, F_{yr} are perpendicular to the forward trajectory of the respective wheels 205, 210 and disposed along a line through respective centers 205c, 210c. That is, the front wheel 205 points in a front wheel-forward direction x_{f} through the center 205c of the front wheel 205, and the rear wheel 210 points in a rear wheel-forward direction xᵣ through the center 210c of the rear wheel 210. The front lateral force F_{yf} points perpendicular to the front wheel-forward direction x_{f}, and the rear lateral force F_{yr} points perpendicular to the rear wheel-forward direction xᵣ.

The vehicle 101 has a mass m which in turn has a center of gravity 215. An example mass m can be, e.g., 1555 kg. The center of gravity 215 is a point at a distance a from a center of the front wheel 205 (i.e., a front axle) and at a distance b from a center of the rear wheel 210 (i.e., a rear axle). An example distance a can be 1.164 meters, and an example distance b can be 1.680 meters. The vehicle 101 has an angular inertia J_{y} about the center of gravity 215. An example of the angular inertia J_{y} can be, e.g., 2580 kg-m². The vehicle 101 has a yaw rate co_{y}, i.e., a rotational speed of the vehicle 101 about a vertical axis or line through the center of gravity 215. The speed of the vehicle 101 can be represented as a forward velocity U (i.e., a vehicle 101 speed) and a lateral velocity V perpendicular to the forward velocity U.

By summing the forces applied to the vehicle 101, the computer 105 can determine the dynamic equations of motion of the vehicle 101:

maₗₐₜ=m(\dot{V}+ω_{y}U)=F_{yf}+F_{yr} (1)

where aₗₐₜ is an overall lateral acceleration of the vehicle 101 and \dot{V} is a rate of change of the lateral velocity V.

By summing the moments about the center of gravity 215, the computer can determine the lateral forces F_{yf}, F_{yr}:

J_{y}\dot{ω}_{y}=aF_{yf}−bF_{yr} (2)

where \dot{ω}_{y} is the rate of change of the yaw rate ω_{y}, i.e., yaw acceleration \dot{ω}_{y}.

In general, the lateral force F_{y} can be approximated with a linear tire model as

F_{y}=Cₐa (3)

where Cₐ is a coefficient representing the lateral stiffness of a tire that would be installed to each wheel 205, 210 and a is a slip angle between a direction of motion of the respective wheel 205, 210 and a respective plane of each wheel 205, 210. Values for Cₐ can be stored in the data store 106.

Combining the previous equations, the computer 105 can determine the model for planar dynamics of the vehicle 101:

$$[ \begin{matrix}\dot{V} \\ {\dot{ω}}_{y}\end{matrix} ] = [ \begin{matrix}- \frac{{C}_{α f} + {C}_{α r}}{mU} & \frac{{bC}_{α r} - {aC}_{α f}}{mU} \\ \frac{{bC}_{α r} - {aC}_{α f}}{{J}_{y} U} & - \frac{{a}^{2} {C}_{α f} + {b}^{2} {C}_{α r}}{{J}_{y} U}\end{matrix} ] [ \begin{matrix}V \\ {ω}_{y}\end{matrix} ] + [ \begin{matrix}\frac{{C}_{α f}}{m} \\ \frac{{aC}_{α f}}{{J}_{y}}\end{matrix} ] δ \qquad ( 4 )$$

where C_{af} is the lateral stiffness coefficient for the front wheel 205 and Cₐᵣ is the lateral stiffness coefficient for the rear wheel 210. Example values for the stiffness coefficients can be, e.g.,

$${C}_{α f} = 1.2 \times {10}^{5} \frac{N}{rad} , {C}_{α r} = 1.85 \times {10}^{5} \frac{N}{rad} .$$

FIG. 3 is a diagram 300 illustrating additional parameters of the vehicle 101 in a 2-dimensional Cartesian coordinate plane. The “2-dimensional Cartesian coordinate plane” is a 2-dimensional coordinate system that the computer 105 and the server 130 use to determine the position and velocity of the vehicle 101. The position of the vehicle 101 can be propagated based on the parameters shown in the diagram 300. The 2-dimensional Cartesian coordinate plane extends in a longitudinal direction and a lateral direction from a predetermined origin point O stored in the data store 106 and/or the server 130. The vehicle 101 has a longitudinal position x and a lateral position y. The vehicle 101 defines a heading angle ϕ_{y} between the vector defined by the forward velocity U and a line extending through the center of gravity 215 along the x direction. The computer 105 can determine a change in a heading angle ϕ_{y} based on the yaw rate ω_{y}:

ϕ_{y}=ω_{y} (5)

where ϕ_{y} is the rate of change of the heading angleϕ_{y}. The computer 105 can determine a longitudinal velocity \dot{x} and a lateral velocity \dot{y} in the 2-dimensional Cartesian coordinate plane:

\dot{x}=Ucos(ϕ_{y})−Vsin(ϕ_{y}) (6)

\dot{y}=Usin(ϕ_{y})+Vcos(ϕ_{y}) (7)

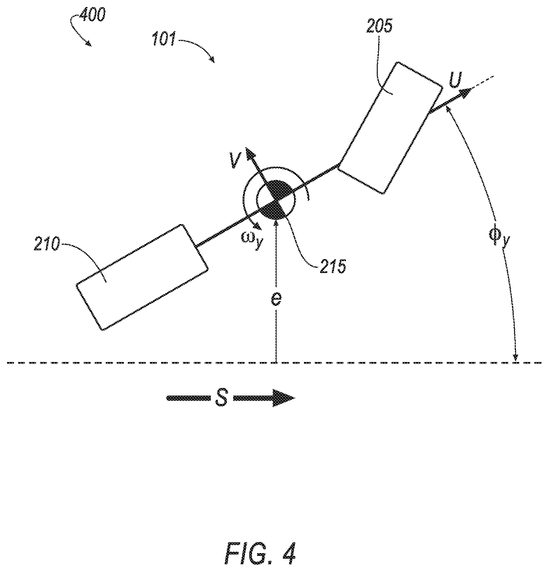

To simply the calculations, the computer 105 can consider the parameters of the vehicle 101 as shown in the diagram 400 of FIG. 4. The computer 105 defines a longitudinal offset s and a lateral offset e. Using small-angle approximations, i.e., sin(ϕ_{y}) ≈ϕ_{y} and cos(ϕ_{y})≈1, the longitudinal velocity \dot{s} is

\dot{s}≈U−Vϕ_{y} (8)

Further assuming that the lateral velocity V is small such that Vϕ_{y}<<1, the computer 105 can calculate the longitudinal velocity \dot{s}, i.e., the vehicle 101 speed, as

\dot{s} [symbol] U (9)

As used herein, a dot above a variable, such as \dot{s}, indicates a time rate of change of the corresponding variable, such as s. The computer 105 can determine values for a variable by integrating its time rate of change over a period of time. For example, the computer 105 can compute the longitudinal position s by integrating the longitudinal velocity \dot{s} over a time period t, e.g., using numerical methods.

The computer 105 can determine a change in the lateral offset e of the center of gravity from a reference line in the s direction:

ė [symbol] V+Uϕ_{y} (10)

where ė is a change in the lateral offset e.

Thus, with equations 4, 5, and 10 listed above, the computer 105 can determine a linear state space model of the planar trajectory of the vehicle:

$$[ \begin{matrix}\dot{V} \\ {\dot{ω}}_{y} \\ {\dot{φ}}_{y} \\ \dot{e}\end{matrix} ] = [ \begin{matrix}- \frac{{C}_{α f} + {C}_{α r}}{mU} & \frac{{bC}_{α r} - {aC}_{α f}}{mU} & 0 & 0 \\ \frac{{bC}_{α r} - {aC}_{α f}}{{J}_{y} U} & - \frac{{a}^{2} {C}_{α f} + {b}^{2} {C}_{α r}}{{J}_{y} U} & 0 & 0 \\ 0 & 1 & 0 & 0 \\ 1 & 0 & U & 0\end{matrix} ] [ \begin{matrix}\dot{V} \\ {\dot{ω}}_{y} \\ {\dot{φ}}_{y} \\ \dot{e}\end{matrix} ] + [ \begin{matrix}\frac{{C}_{α f}}{m} \\ \frac{{aC}_{α f}}{{J}_{y}} \\ 0 \\ 0\end{matrix} ] δ \qquad ( 11 )$$

The matrices in Equation 11 can be represented in compact notation:

\dot{M}=A_{c}M+B_{c}δ (12)

where M=[V ω_{y} ϕ_{y} e]^{T}, i.e., states that the computer 105 can determine based on collected data 115 from the sensors 110, \dot{M} is the time rate of change of the vehicle states M, the T superscript is the transpose matrix operation that inverts columns into rows and rows into columns, A_{c} is the 4×4 matrix multiplied to M, and B_{c} is the 4×1 matrix multiplied to δ in Equation 11.

As used herein, a “vehicle state” is a parameter of the vehicle 101, e.g., vehicle 101 speed, acceleration, steering angle, lateral offset, yaw rate, yaw acceleration, etc. The example vehicle states shown here are the lateral velocity V, the yaw rate ω_{y}, the heading angle ϕ_{y}, and the lateral offset e. A “vehicle state model” is a set of values for each of the vehicle states determined by the computer 105 and/or the server 130.

The computer 105 can determine the values for Equation 11 for discrete timesteps k. The state-space representation can be discretized via a zero-order hold transformation to

M(k+1)=A_{d}M(k)+B_{d}δ(k) (13)

where A_{d}, B_{d} are the discrete versions of A_{c}, B_{c} with sampling time tₛₐₘₚₗₑ. That is, the computer 105 can predict the future trajectory of the vehicle 101 by stepping the vehicle state model forward by a period of time t subdivided into timesteps k of length tₛₐₘₚₗₑ, iteratively determining each successive value k+1 based on the values from the iteration corresponding to k. The zero-order hold transformation converts discrete data 115 into a continuous, piecewise function by holding each data point 115 for the sampling time tₛₐₘₚₗₑ.

The computer 105 can collect data 115 of the vehicle 101 to account for steering disturbances δ_{w} applied to one or more of the wheels 205, 210. As used herein, a “steering disturbance” is a change in the steering angle δ caused by a source external to the steering component 120, e.g., a wheel misalignment, tire wear, road bank, strong winds, etc. The steering disturbance δ_{w} may be difficult to measure directly, so the computer 105 can compare a vehicle state model to measured states M that the computer 105 can measure to model the steering disturbance δ_{w}. The steering disturbance δ_{w} can be determined based on the states M and the vehicle 101 speed U, incorporated as part of the matrices A_{c}, B_{c}, as follows:

M=A_{c}M+B_{c}δ+B_{c}δ_{w} (14)

μ=C_{c}M (15)

where C_{c} is a state matrix that selects a subset μ of the four states of M to consider. For example, if the computer 105 determines only to consider yaw rate ω_{y} and lateral offset e, the state matrix C_{c} can be:

$${C}_{c} = [ \begin{matrix}0 & 1 & 0 & 0 \\ 0 & 0 & 0 & 1\end{matrix} ] \qquad ( 16 )$$

That is, the computer 105 is capable of collecting data 115 about all four states shown in M, and the computer 105 can determine to collect data 115 for only a subset of the states, represented by μ. The computer 105 can collect data 115 for any or all of the four states of M to consider in order to identify the wheel misalignment condition. The computer 105 can determine which of the states M to include in the subset μ based on, e.g., computing resources, sensor accuracy, etc.

The computer 105 can use a vehicle state model to determine the current vehicle state data. The computer 105 can determine values of the vehicle state model for \dot{M} and μ, represented with “hat” symbols as \hat{\dot{M}}, \hat{μ}:

M=A_{c}\hat{M}+B_{c}δ+B_{c}\hat{δ}_{w}+Lₚ(μ−\hat{μ}) (17)

μ=C_{c}\hat{M} (18)

where Lₚ is a model state update feedback, as described below, and δ_{w} is a modeled steering disturbance.

The computer 105 can determine the rate of change of the steering disturbance δ_{w}:

\hat{\dot{δ}}_{w}=L_{d}(μ−μ) (19)

where L_{d} is a disturbance estimation feedback, as described below. As described above, the computer 105 can determine a modeled steering disturbance \hat{δ}_{w} by integrating the rate of change \hat{\dot{δ}}_{w}, e.g., using numerical methods.

In order to determine whether to identify the wheel misalignment condition, the computer 105 can determine a difference between the current vehicle state data and the corresponding vehicle state model data. For example, the computer 105 can determine differences for the vehicle state data \tilde{M} and the steering disturbance \tilde{δ}_{w}:

$$\begin{matrix}\tilde{M} = M - \hat{M} & ( 20 ) \\ {\tilde{δ}}_{w} = {δ}_{w} - {\hat{δ}}_{w} & ( 21 ) \\ [ \begin{matrix}{M}^{\dot{\sim}} \\ {{δ}^{\dot{\sim}}}_{w}\end{matrix} ] = [ \begin{matrix}{A}_{c} + {L}_{p} {C}_{c} & {B}_{c} \\ - {L}_{d} {C}_{c} & 0\end{matrix} ] [ \begin{matrix}\tilde{M} \\ {\tilde{δ}}_{w}\end{matrix} ] & ( 22 )\end{matrix}$$

As described above, measuring the value of the steering disturbance δ_{w} may be difficult, so the matrices of Equations 20-22 allow the computer 105 to determine the difference in the steering disturbance \tilde{δ}_{w}, and thus determine that the modeled steering disturbance \hat{δ}_{w} is substantially the actual steering disturbance δ_{w}. The computer 105 can designate feedback matrices L_{d}, Lₚ where Lₚ is the model state update feedback and L_{d} is the disturbance estimation feedback. To determine the feedback matrices L_{d}, Lₚ, the computer determines a matrix having specified negative eigenvalues:

$$[ \begin{matrix}{A}_{c} + {L}_{p} {C}_{c} & {B}_{c} \\ - {L}_{d} {C}_{c} & 0\end{matrix} ]$$

The eigenvalues can be determined to reduce the differences \tilde{M} and \tilde{δ}_{w} to 0, adjusting the vehicle state model to align with the collected data 115. To determine the eigenvalues and the feedback matrices L_{d}, Lₚ, the computer 105 can solve an infinite-horizon linear-quadratic regulator (LQR) equation:

\dot{ξ} =Āξ+B̅u (23)

J=∫ₜ_{₀}^{∞}(ξ^{T}Qξ+u^{T}Ru+2ξ^{T}Nu)dt (24)

u=K̅ξ (25)

where ξ is a combined matrix of

$$[ \begin{matrix}\tilde{M} \\ {\tilde{δ}}_{w}\end{matrix} ] ,$$

J is a quadratic cost function, u is the cost associated with the cost function to be minimized, {Q, R, N} are design parameters specified for the vehicle state data model. {Ā, B̅, K̅} are defined as

$$\begin{matrix}\overline{A} = [ \begin{matrix}{A}_{c}^{T} & 0 \\ {B}_{c}^{T} & 0\end{matrix} ] & ( 26 ) \\ \overline{B} = [ \begin{matrix}{C}_{c}^{T} \\ 0\end{matrix} ] & ( 27 ) \\ \overline{K} = [ \begin{matrix}- {L}_{p}^{T} & {L}_{d}^{T} ]\end{matrix} & ( 28 )\end{matrix}$$

Example values for {Q, R, N} may be, e.g.,

$$\begin{matrix}Q = [ \begin{matrix}0.01 & 0 & 0 & 0 & 0 \\ 0 & 1 & 0 & 0 & 0 \\ 0 & 0 & 5 & 0 & 0 \\ 0 & 0 & 0 & 10 & 0 \\ 0 & 0 & 0 & 0 & 5\end{matrix} ] & ( 29 ) \\ R = [ \begin{matrix}0.1 & 0 & 0 \\ 0 & 0.1 & 0 \\ 0 & 0 & 0.1\end{matrix} ] & ( 30 ) \\ N = {[ 0 ]}_{5 \times 3} & ( 31 )\end{matrix}$$

i.e., N is a zero matrix with dimensions 5×3.

The computer 105 can determine the LQR feedback, e.g., as

K̅=R⁻¹(B̅^{T}P+N^{T}) (32)

where P is found by solving the continuous time algebraic Riccati equation:

Ā^{T}P+PĀ−(PB̅+N)R⁻¹(PB̅+N)^{T}+Q=0 (33)

Thus, the computer 105 can transpose the matrix to find the asymptotic stability, using conventional methods, and thus the feedback matrices Lₚ, L_{d} as follows:

$${[ \begin{matrix}{A}_{c} + {L}_{p} {C}_{c} & {B}_{c} \\ - {L}_{d} {C}_{c} & 0\end{matrix} ]}^{T} = \overline{A} + \overline{B} \overline{K} \qquad ( 34 )$$

Example values for the feedback matrices Lₚ, L_{d} can be, e.g.,

$$\begin{matrix}{L}_{p} = [ \begin{matrix}26.3 & 0.7 & 0.8 \\ 18.9 & 0.5 & 0.6 \\ 0.5 & 22.3 & 1.2 \\ 0.6 & 1.2 & 31.7\end{matrix} ] & ( 35 ) \\ {L}_{d} = [ \begin{matrix}22.3 & 0.5 & 0.6 ]\end{matrix} & ( 36 )\end{matrix}$$

Upon determining the feedback matrices Lₚ, L_{d}, the computer 105 can update the vehicle state model. As described above, the computer 105 can iteratively determine the vehicle state model based on previously determined values of the states \hat{M} and the steering disturbance \hat{δ} _{w}. Using previous values of \hat{M}, \hat{δ}_{w}, and, by extension, Lₚ, L_{d}, the computer 105 can refine the values of the future iterations of \hat{M}, \hat{δ}_{w}, increasing accuracy of the vehicle state model.

The computer 105 can determine whether the modeled steering disturbance \hat{δ} _{w} exceeds a predetermined threshold. If the steering disturbance \hat{δ} _{w} exceeds a predetermined threshold, the computer 105 can identify the wheel misalignment condition. The predetermined threshold can be determined based on, e.g., empirical testing, simulation modeling, etc., e.g., empirical testing and/or simulating could include correlating wear on tires attached to the wheels 205, 210 and predetermined values of the steering disturbance δ_{w}. The predetermined threshold can be determined based on, e.g., empirical testing, simulation modeling, etc., correlating wear on tires attached to the wheels 205, 210 and predetermined values of the steering disturbance δ_{w}. The testing may include disturbing one of the wheels 205, 210 to a specified steering disturbance δ_{w} and measuring the resulting wear on the tire after moving the vehicle 101 around a track. An example predetermined threshold for the steering disturbance \hat{δ} _{w} can be, e.g., 0.05 radians.

Upon identifying the wheel misalignment condition, the computer 105 can actuate one or more components 120 to address the condition. For example, the computer 105 can actuate a propulsion 120 to move the vehicle 101 to a repair station to repair or replace one of the wheels 205, 210. In another example, the computer 105 can actuate the steering component 120 to rotate the front wheels 205 to counteract the steering disturbance δ_{w}. Alternatively or additionally, the computer 105 can apply an operating mode for a propulsion 120 that restricts a vehicle 101 speed to a predetermined maximum speed.

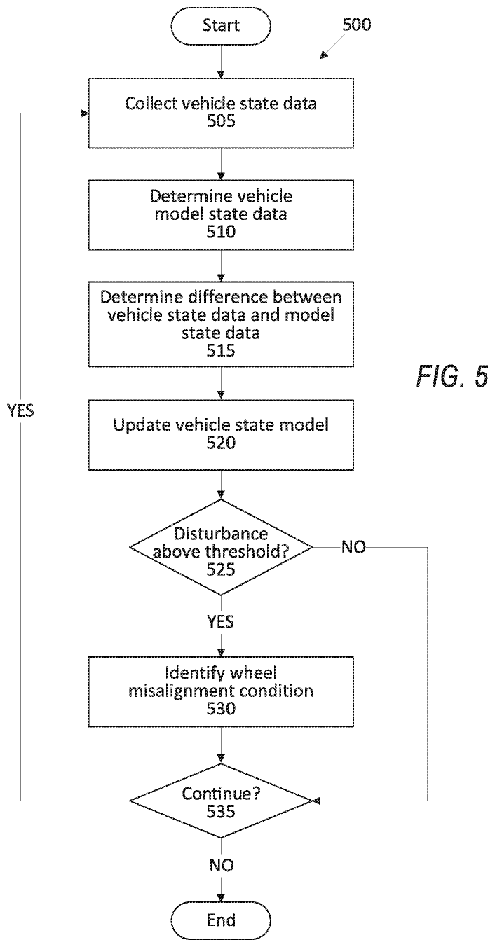

FIG. 5 illustrates an example process 500 for identifying a wheel misalignment condition. The process 500 begins in a block 505, in which the computer 105 collects data 115 from sensors 110 about a plurality of vehicle states. For example, the computer 105 can collect data 115 regarding a speed U, a lateral velocity V, a yaw rate ω_{y}, a heading angleϕ_{y}, and/or a lateral offset e. As described above, the computer 105 can refer to the collected state data 115 as M.

Next, in a block 510, the computer 105 determines vehicle model state data 115 for the states collected in the block 505. For example, the computer 105 can determine vehicle model state data 115 for each of a vehicle 101 speed, a lateral velocity \hat{V}, a yaw rate \hat{ω}_{y}, a heading angle \hat{ϕ}_{y}, and a lateral offset ê. As described above, the computer 105 can refer to the modeled data 115 as \hat{M}.

Next, in a block 515, the computer 105 can determine a difference between the collected vehicle state data 115 and the vehicle model state data 115. Specifically, the computer 105 can determine a difference in the states \tilde{M}=M−\hat{M} to determine a difference in steering disturbance \tilde{δ}_{w}=δ_{w}−\hat{δ}_{w}. The computer 105 can determine the differences based on, e.g., the difference calculations shown in Equation 22 above.

Next, in a block 520, the computer 105 updates the vehicle state model. As described above, the computer 105 can use feedback matrices Lₚ, L_{d} based on determined values of the states M to refine the vehicle state model, increasing the accuracy and precision of the vehicle state model relative to the collected data 115 and reducing the difference M.

In the block 525, the computer 105 determines whether the modeled disturbance \hat{δ}_{w}, representing the actual steering disturbance δ_{w}, is above a predetermined threshold, e.g., 0.05 radians. As described above, the predetermined threshold can be based on, e.g., empirical testing, dynamic simulation models, etc., correlating wear on tires to the steering disturbance δ_{w}. If the steering disturbance \hat{δ}_{w} is above the threshold, the process 500 continues in a block 530. Otherwise, the process 500 continues in the block 535.

In the block 530, the computer 105 identifies the wheel misalignment condition. Upon identifying the wheel misalignment condition, the computer 105 can actuate one or more components 120 to address the condition. For example, the computer 105 can actuate a propulsion 120 to move the vehicle 101 to a repair station to repair or replace one of the wheels 205, 210.

In the block 535, the computer 105 determines whether to continue the process 500. For example, the computer 105 can determine not to continue when the vehicle 101 is powered off. If the computer 105 determines to continue, the process 500 returns to the block 505 to collect more data 115. Otherwise, the process 500 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices discussed herein, including the computer 105 and server 130, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory storing instructions executable by the processor to:
determine that a steering disturbance based on a difference between current vehicle state data and corresponding vehicle state model data exceeds a threshold, the vehicle state model including a yaw rate and a vehicle speed; and
then, identify a wheel misalignment condition.

2. The system of claim 1, wherein the instructions further include instructions to adjust a steering component based on the steering disturbance.

3. The system of claim 1, wherein the vehicle state data further include at least one of a lateral offset or a lateral velocity.

4. The system of claim 1, wherein the instructions further include instructions to update the vehicle state model based on the current vehicle state data.

5. The system of claim 1, wherein the instructions further include instructions to update the vehicle state model based on the difference.

6. The system of claim 1, wherein the vehicle state model includes state data of at least one of a lateral velocity, a heading angle, or a lateral offset.

7. The system of claim 1, wherein the instructions further include instructions to identify the difference based on a model state update feedback and a disturbance estimation feedback.

8. The system of claim 7, wherein the instructions further include instructions to determine the model state update feedback and the disturbance estimation feedback based on a minimized cost function.

9. The system of claim 1, wherein the instructions further include instructions to update the state model based on the steering disturbance.

10. The system of claim 1, wherein the instructions further include instructions to identify the steering disturbance based on a minimized cost function.

11. A method, comprising:
determining that a steering disturbance based on a difference between collected vehicle state data and corresponding state data from a vehicle state model exceeds a threshold, the vehicle state model including a yaw rate and a vehicle speed; and
then, identifying a wheel misalignment condition.

12. The method of claim 11, further comprising adjusting a steering component based on the steering disturbance.

13. The method of claim 11, wherein the collected vehicle state data include at least one of a lateral offset or a lateral velocity.

14. The method of claim 11, wherein the vehicle state model includes state data of at least one of a lateral velocity, a heading angle, or a lateral offset-.

15. The method of claim 11, further comprising identifying the steering disturbance based on a model state update feedback and a disturbance estimation feedback.

16. A system, comprising:
a wheel;
means for determining that a steering disturbance based on a difference between collected vehicle state data and corresponding state data from a vehicle state model exceeds a threshold, the vehicle state model including data of a yaw rate and a vehicle speed; and
means for identifying a wheel misalignment condition of the wheel.

17. The system of claim 16, further comprising means for adjusting a steering component based on the steering disturbance.

18. The system of claim 16, wherein the collected vehicle state data include at least one of a lateral offset, a lateral velocity, or a lateral offset.

19. The system of claim 16, wherein the vehicle state model includes state data of at least one of a lateral velocity, a heading angle, or a lateral offset.

20. The system of claim 16, further comprising means for identifying the steering disturbance based on a model state update feedback and a disturbance estimation feedback.
